(19) United States
(12) Patent Application Publication
(10) Pub. No.: US 2016/0172793 A1
(43) Pub. Date: Jun. 16, 2016

(54) REDUCING INEQUALITY IN UNSHIELDED LINE LENGTHS

(71) Applicant: INTEL CORPORATION, Santa Clara, CA (US)

(72) Inventor: Kuan-Yu Chen, Hillsboro, OR (US)

(73) Assignee: INTEL CORPORATION, Santa Clara, CA (US)

(21) Appl. No.: 14/567,767

(22) Filed: Dec. 11, 2014

(51) Int. Cl. H01R 13/6592; H01R 43/16

(52) U.S. Cl. CPC H01R 13/6592; H01R 43/16

(57) ABSTRACT

Techniques for signal line connecting are described herein. An apparatus may include a first signal contact pad and a second signal contact pad adjacent to the first signal contact pad. The apparatus also includes a ground pad. The contact pads are disposed in an arrangement reducing inequality between unshielded lengths of a first signal line, a second signal line, and a drain line lines to be respectively connected to the first signal contact pad, the second signal contact pad, and the ground contact pad.

### TECHNICAL FIELD

This disclosure relates generally to line lengths of unshielded lines. Specifically, this disclosure relates to an arrangement of contact pads to reduce inequality of unshielded line lengths to be connected to the contact pads.

### BACKGROUND

In a shielded differential pair (SDP) cable, drain wires are commonly used to dissipate electric charge build up as signals propagate across the cable. A drain line is connected to a ground pad at a connector to ground electrical noise that may be caused by the electric charge build up. For example, a shielded differential pair (SDP) may include a shield that is stripped to expose a drain line as well as each signal line in the SDP. The unshielded portion of the drain line may be configured to be connected to a ground contact pad of a connector, while the unshielded portion of each signal line in the SDP may be connected to signal contact pads of the connector. In some cases, the length of the unshielded portion of the drain line is longer than the unshielded portions of the signal lines in the SDP. For example, the unshielded portion of the drain line may be longer to accommodate a connection of the drain line to a ground contact pad that is used to ground two or more drain lines from other SDP's. When the unshielded portion of the drain line is longer than either of the unshielded portions of the signal lines, higher impedance may occur along with crosstalk introduction.

### BRIEF DESCRIPTION OF THE DRAWINGS

FIG. 1 is a block diagram illustrating a computing system having a transmission line and a pad arrangement to reduce inequality in unshielded line lengths;

FIG. 2 is a block diagram illustrating a first pad arrangement to reduce inequality in unshielded line lengths;

FIG. 3 is a block diagram illustrating a second pad arrangement to reduce inequality in unshielded line lengths;

FIG. 4 is a block diagram illustrating a third pad arrangement to reduce inequality in unshielded line lengths;

FIG. 5 is a block diagram illustrating a fourth pad arrangement to reduce inequality in unshielded line lengths;

FIG. 6 is a block diagram illustrating a fifth pad arrangement to reduce inequality in unshielded line lengths;

FIG. 7 is a block diagram illustrating a sixth pad arrangement to reduce inequality in unshielded line lengths;

FIG. 8 is a block diagram illustrating a seventh pad arrangement to reduce inequality in unshielded line lengths;

FIG. 9 is a block diagram illustrating an eighth pad arrangement to reduce inequality in unshielded line lengths;

FIG. 10 is a block diagram illustrating a ninth pad arrangement to reduce inequality in unshielded line lengths;

FIG. 11 is a block diagram illustrating a tenth pad arrangement to reduce inequality in unshielded line lengths;

FIG. 12 is a block diagram illustrating an eleventh pad arrangement to reduce inequality in unshielded line lengths; and

FIG. 13 is a block diagram illustrating a method for reducing inequality in unshielded line lengths.

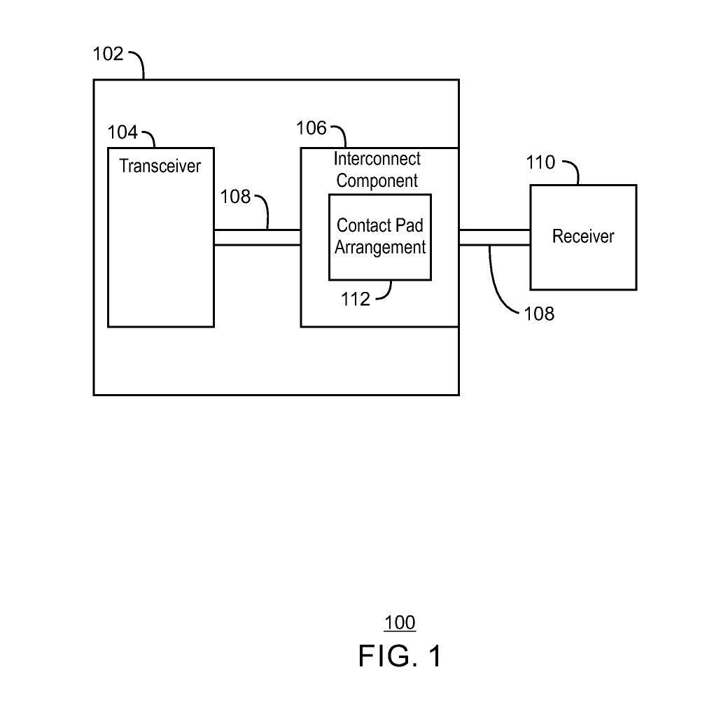

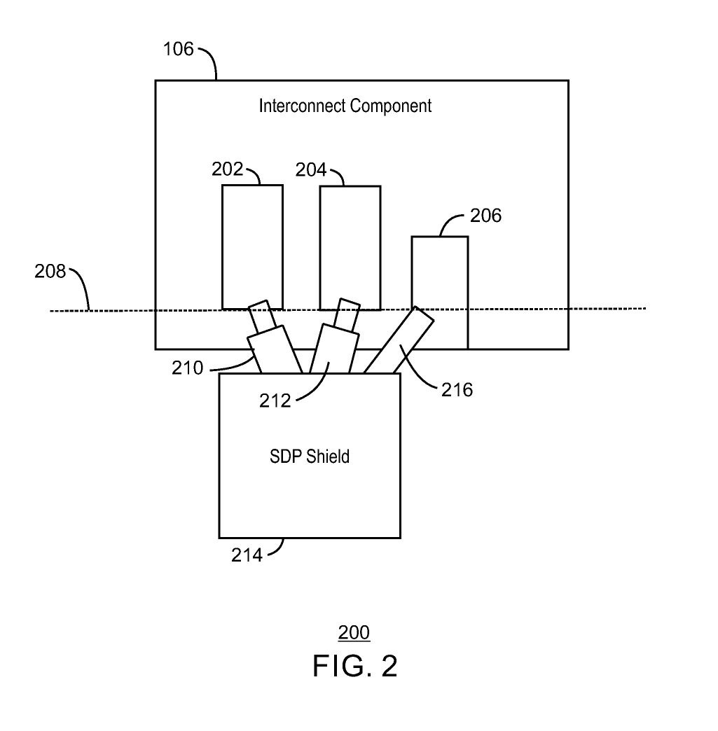

In some cases, the same numbers are used throughout the disclosure and the figures to reference like components and features. Numbers in the 100 series refer to features originally found in FIG. 1; numbers in the 200 series refer to features originally found in FIG. 2; and so on.

### DESCRIPTION OF THE EMBODIMENTS

The techniques described herein relate to reducing inequality in unshielded lengths of signal and drain lines. As discussed above, a drain line may be used to ground electrical noise that built up in a signal line due to signal propagation. Grounding may occur at a connector, such as a interconnect paddle card. Signal lines may also be connected to the interconnect paddle card. In the case of a shielded signal line, such as a shielded differential pair (SDP), the shield is removed to expose the signal lines and drain line. Typically, the contact pads, configured to be coupled to unshielded portions of the signal lines and the drain line, are disposed at the connector in a linear array. In this scenario, unshielded portions configured to be connected at the contact pads may be of unequal lengths. In many cases, the unshielded portion of the drain line is longer than the unshielded portion of the signal lines of the SDP. In such cases, the unequal lengths may increase impedance discontinuity and introduce crosstalk noise that degrades signal quality and causes data transfer errors impeding proper function of a system.

The techniques described herein include an arrangement of contact pads configured to reduce an inequality in the length of the unshielded portion of the drain line in comparison to the unshielded portions of the signal lines of the SDP. For example, the ground contact pad may be extended beyond a linear boundary associated with the signal contact pads. In this example, the ground contact pad may either be longer than the signal contact pads, or having at least a portion of the ground contact pad disposed beyond the linear boundary. A linear boundary, as referred to herein, is a line associated with a given arrangement as discussed in more detail below.

FIG. 1 is a block diagram illustrating a computing system having a transmission line and a pad arrangement to reduce inequality in unshielded line lengths. The computing system 100 may include a printed circuit board (PCB) 102. PCB 102 may be configured to connect a transceiver 104 to a connector 106. The connector 106, may be referred to herein as an interconnect component. An example of the interconnect component 106 may include a paddle card configured to connect a SDP cable 108 to a receiver 110. In some cases, the receiver 110 may be a component of a second computing system, peripheral computing device, and the like. In some cases, the SDP cable 108 is a Universal Serial Bus (USB) transmission line including an SDP shield and one or more SDP signal lines including one or more drain lines. In addition, the SDP cable 108 can be disposed inside or outside of the computing system 100, on both the inside and the outside of the computing system 100, or any combination thereof.

As illustrated in FIG. 1, the interconnect component 106 may include a contact pad arrangement 112. The contact pad arrangement 112 may be configured to reduce inequality in lengths of unshielded portions of the SDP signal lines and an associated drain line.

The block diagram of FIG. 1 is not intended to indicate that the computing system 100 is to include all of the components shown in FIG. 1. Further, the computing system 100 may include any number of additional components not shown in FIG. 1, depending on the details of the specific implementation.

FIG. 2 is a block diagram illustrating a first pad arrangement to reduce inequality in unshielded line lengths. A first arrangement 200 includes a first signal pad 202 and an adjacent a second signal pad 204, as well as a ground contact pad 206 of the interconnect component 106. As illustrated in FIG. 2, the ground contact pad 206 extends beyond a boundary line indicated at 208.

In this first arrangement 200, signal lines 210 and 212 are differential signal line pairs extending from a SDP shield 214. A drain line 216 also extends from the SDP shield 214. The signal lines 210 and 212 are unshielded portions of an SDP signal line pair. Likewise, the drain line 216 is an unshielded portion associated with the SDP signal line pair. As discussed above, the arrangement 200 of contact pads 202, 204, 206 is to reduce inequality of unshielded portions, such as the unshielded portions 210, 212, and 216. By extending the ground contact pad 206 beyond the boundary line 208 associated with the signal line contact pads 202 and 204, the length of the unshielded portion 216 of the drain line may be closer to the length of the unshielded portions 210 and 212 of the signal lines than if the ground contact pad did not extend beyond the boundary line 208.

Reference numerals for the unshielded portions, including portions 210 and 212 of respective signal lines, as well as numbering for the unshielded portion 216 of the drain line may be preserved throughout the following figures where applicable. Similarly, reference numerals for contact pads 202, 204, and 206 may also be preserved throughout the following figures where applicable.

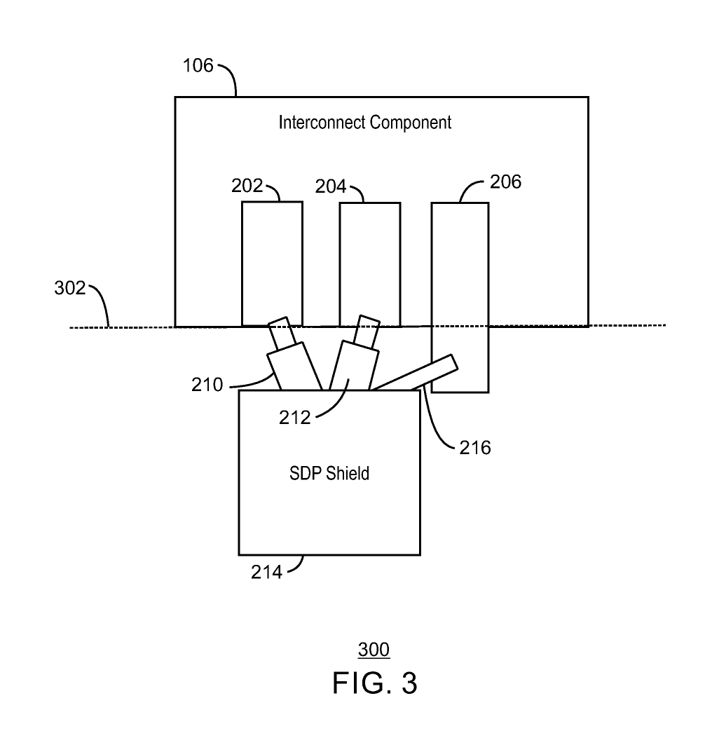

FIG. 3 is a block diagram illustrating a second pad arrangement to reduce inequality in unshielded line lengths. In FIG. 3, an arrangement 300 is similar to the arrangement 200 of FIG. 2. However, in this example, a boundary line 302 is associated with an edge of the interconnect component 106. Therefore, the ground contact pad 206 extends beyond an edge of the interconnect component 106, thereby disposing the ground contact pad 206 closer to the unshielded portion 216 of the drain line.

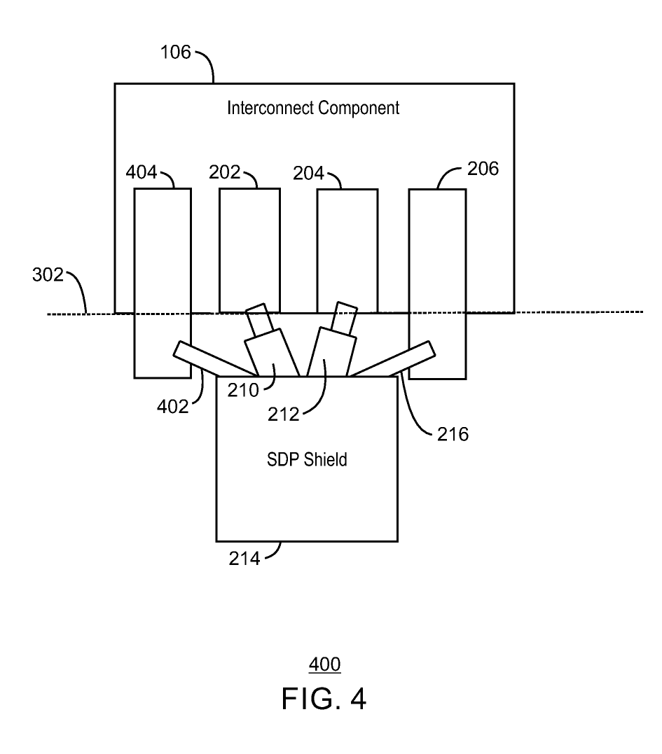

FIG. 4 is a block diagram illustrating a third pad arrangement to reduce inequality in unshielded line lengths. In some cases, a SDP signal line pair may include multiple drain lines. As illustrated in FIG. 4, a SDP signal line may include a first signal line, a second signal line, and two drain lines. Unshielded portions, such as the unshielded portions 210, 212, and 216, of FIG. 2, and indicated. In this example, the drain line is a first drain line and the unshielded portion 216 is a first unshielded portion. A second unshielded portion 402 may be coupled to a second ground contact pad 404.

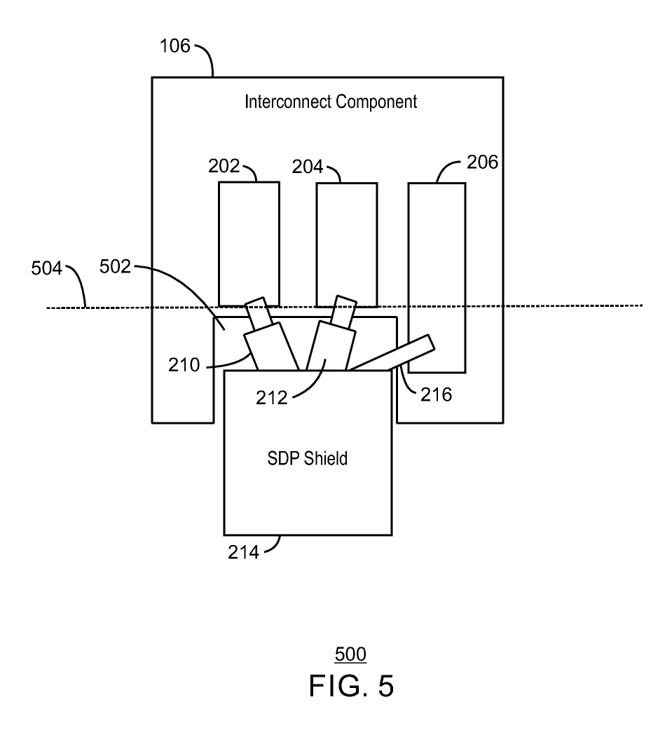

It may be important to note that the boundary 302 in FIG. 4 need not be associated with an edge of the interconnect component as illustrated in FIG. 4 and FIG. 3. Instead, the boundary may be associated with the signal contact pads 202 and 204, as indicated by the boundary 208 of FIG. 2. Further, the arrangements discussed in relation to FIGS. 2-4, as well as in relation to FIGS. 5-12 below, need not require a ground contact pad, such as the ground contact pad 206 to be of a longer length than the contact pads 202 and 204 associated with the signal lines. Although not illustrated in the Figures herein, a ground contact pad, such as the ground contact pad 206 of FIG. 4 may be of similar dimensions while still extending past an associated boundary line such that inequalities in the unshielded lines are reduced.

FIG. 5 is a block diagram illustrating a fourth pad arrangement to reduce inequality in unshielded line lengths. In some cases, the interconnect component 106 may be formed to accommodate a ground contact pad extension. As illustrated in FIG. 5, the interconnect component includes a recess, generally indicated by the arrow 502. In this example, a boundary line 504 is associated with the edge of the recess 502, or a linear boundary of the signal contact pad 202 and the signal contact pad 204. The ground contact pad 206 extends beyond the boundary line 504, such that unshielded portions 210 and 212 of an SDP signal line pair and the unshielded portion 216 are substantially similar in length. In other words, inequalities in length between each portion 210, 212, and 216 are reduced in this arrangement.

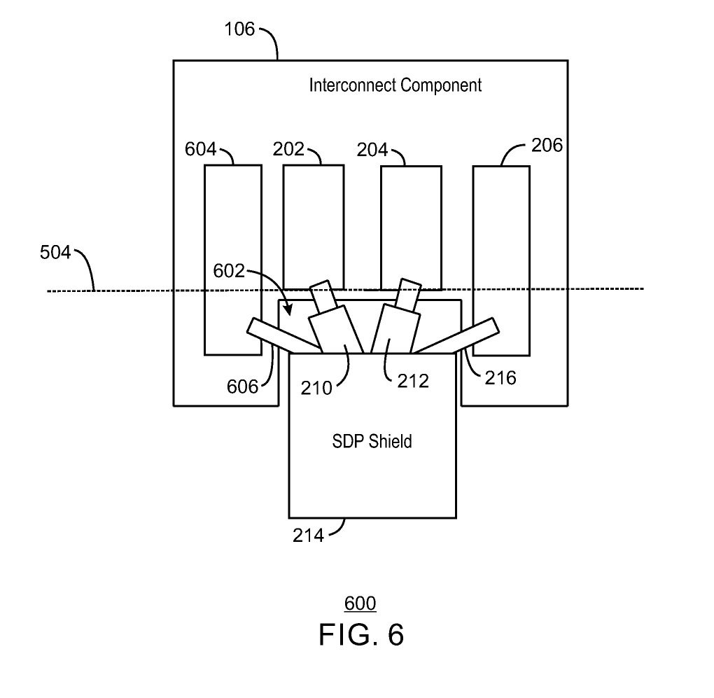

FIG. 6 is a block diagram illustrating a fifth pad arrangement to reduce inequality in unshielded line lengths. As discussed above in regard to FIG. 4, in some cases, multiple drain lines may be incorporated within the SDP signal line. As illustrated in FIG. 6, a recess indicated at 602 may be formed in the interconnect component 106. A boundary line, such as the boundary line 504 of FIG. 5, may be disposed at an edge of the recess 602. In this scenario, the ground contact pad 206 is a first ground contact pad, and a second ground contact pad 604 may be disposed on a portion of the interconnect component 106 that is outside the recess 602. Similar to FIG. 4, the SDP signal line may include first and second unshielded signal line portions, indicated at 210 and 212, as well as first and second unshielded drain line portions, indicated at 216 and 606. In this arrangement, inequality of lengths of unshielded lines may be reduced.

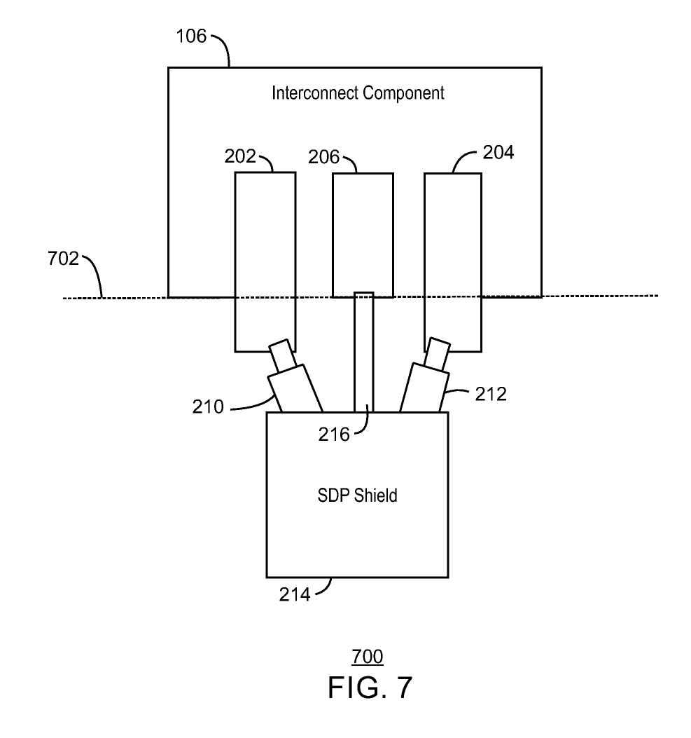

FIG. 7 is a block diagram illustrating a sixth pad arrangement to reduce inequality in unshielded line length. In this arrangement, rather than extending a ground contact pad, signal contact pads 202 and 204 may be extended beyond a boundary line associated with a ground contact pad 206, as indicated by the dashed line 702. In this example, the ground contact pad 206 is disposed between the extended signal contact pads 202 and 204. In this arrangement, lengths of unshielded portions include the first unshielded portion 210 of the first signal line in the SDP signal line pair, the second unshielded portion 212 of a second signal line in the SDP signal line pair, and the third unshielded portion 216 of a drain line of the SDP signal line.

As discussed above in regard to FIG. 4, it may be important to note that the boundary line 702 in FIG. 7 need not be associated with an edge of the interconnect component, but may be associated with the ground contact pad 206, wherein the signal contact pads 202 and 202 do not extend past an edge of the interconnect component 106, but past the boundary line 702 associated with the ground contact pad 206. Further, the arrangements need not require the signal contact pads 202 and 204 to be of a longer length than the ground contact pad 206. Although not illustrated in the Figures herein, any extended contact pad may be extended by way of disposition alone, rather than length as well as disposition. In any case, the arrangements described herein reduce inequality in unshielded portions of signal lines, including the portions 210, 212, and 216, to be coupled to pads 202, 204, and 206, respectively, of interconnect connector 106.

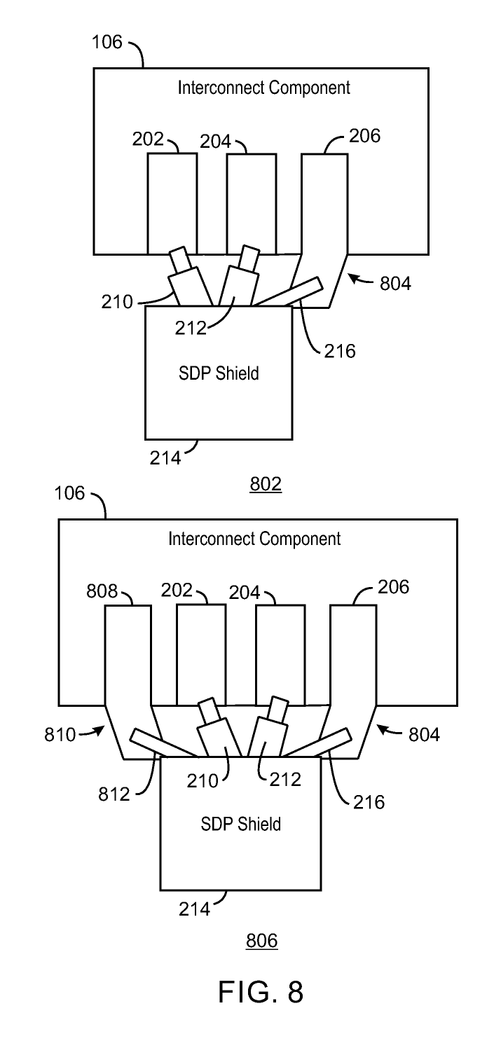

FIG. 8 is a block diagram illustrating a seventh pad arrangement to reduce inequality in unshielded line lengths. In a first arrangement 802, the ground contact pad 206 includes an angled portion, as indicated at 804. In other words, the ground contact pad 206 may be angled inward toward an adjacent signal contact pad, such as the signal contact pad 204. The angled portion 804 provides a further decrease in length needed for the unshielded portion 216 of the drain line to be connected to the ground contact pad 206.

In a second arrangement 806, the SDP signal line includes two drain lines. As illustrated in the arrangement 806, another ground contact pad 808 includes an angled portion as indicated by the arrow 810, and is configured to connect to an unshielded portion 812 of another drain line. The arrangements 802 and 806 of FIG. 8 provide a reduction in inequality of unshielded portions including portions 210, 212, 216, and 812.

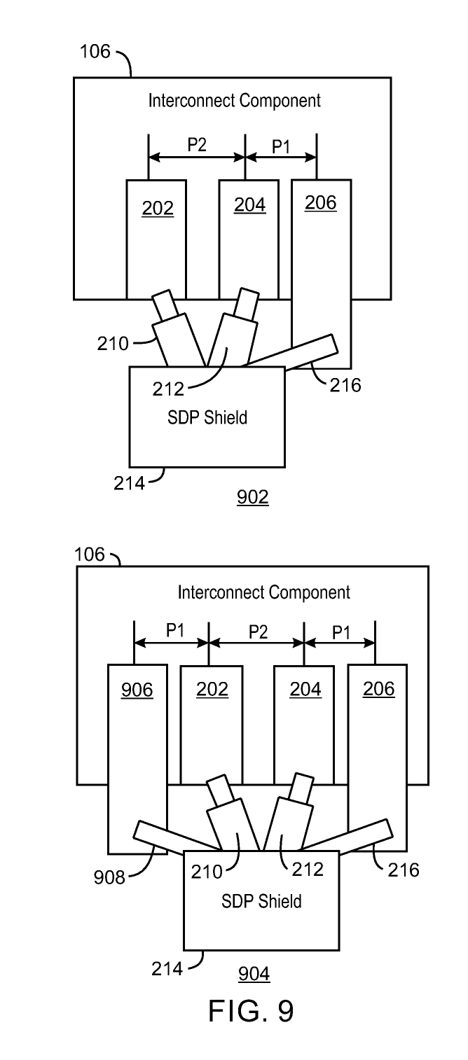

FIG. 9 is a block diagram illustrating an eighth pad arrangement to reduce inequality in unshielded line lengths. In some cases, spacing between contact pads may also reduce inequality in unshielded line portions. The spacing between the center of two adjacent pads, such as signal pad 202 and 204, may be referred to herein as a pitch. FIG. 9 illustrates a first arrangement 902 of varying pitch when only ground contact pad 206 is disposed on the interconnect component 106, while a second arrangement 904 includes ground contact pad 206 and a second ground contact 906. In either arrangement, a pitch between a ground contact pad and a signal contact pad is indicated by “P1,” while a pitch between two signal contact pads is indicated by “P2.” In these arrangements, P2 is greater than P1. By varying P1 in relation to P2, inequalities in lengths of exposed or unshielded portions including 210, 212, 216 in the first arrangement, as well as portions 210, 212, 216, and 908 of the second arrangement, may be reduced.

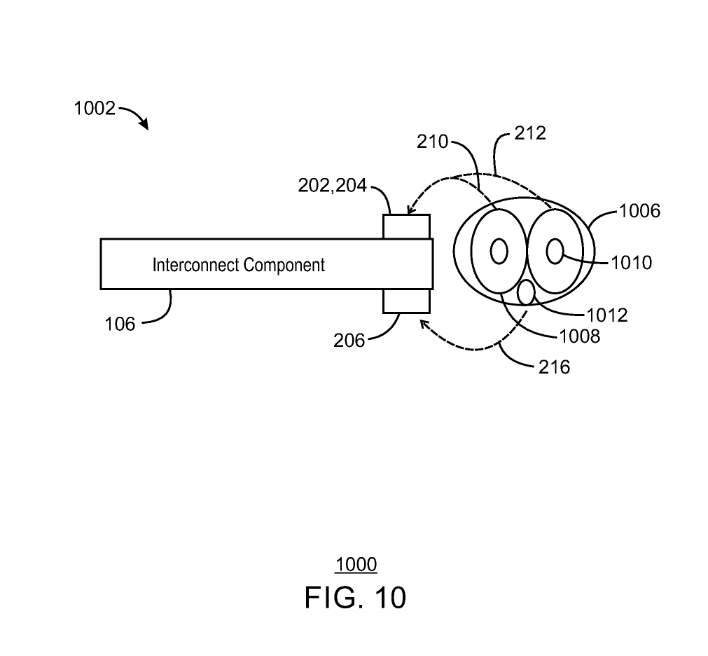

FIG. 10 is a block diagram illustrating a ninth pad arrangement to reduce inequality in unshielded line lengths. FIG. 10 illustrates an arrangement 1002 wherein unshielded portions are connected to the interconnect component 106. In 1002, a cross sectional view of the SDP signal line is indicated at 1006. The SDP signal line includes two signal lines in a differential signal line pair as indicated at 1008 and 1010, as well as a drain line 1012. Unshielded portions 210, 212, and 216 are to be connected to the interconnect component 106, as indicated by the dashed arrows. In this arrangement, the signal contact pads 202 and 204 are disposed on one side of the interconnect component 106, while the ground contact pad 206 is disposed on an opposite side. In this example, length inequalities of the unshielded portions 210, 212, and 216 may be reduced by the arrangement 1002 of the contact pads.

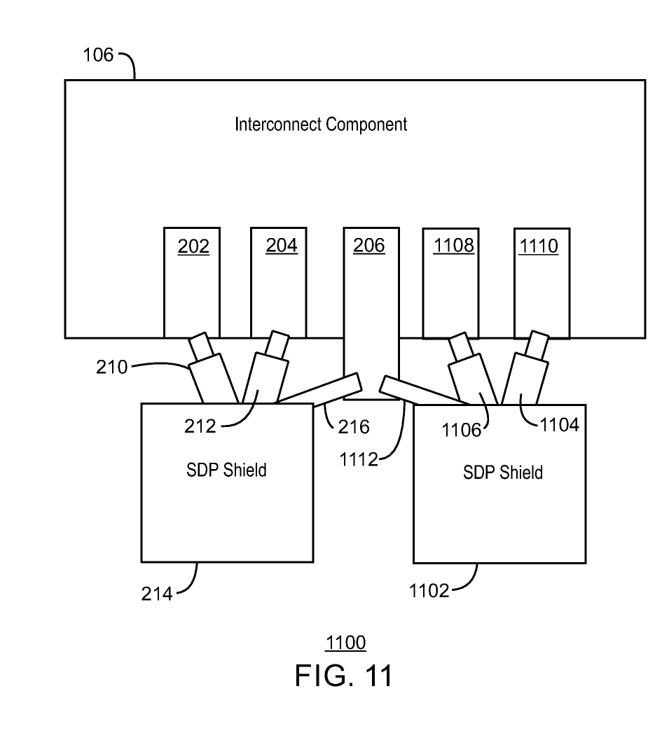

FIG. 11 is a block diagram illustrating a tenth pad arrangement to reduce inequality in unshielded line lengths. The techniques described herein may be used to reduce length inequalities as well as combine connections of drain lines in a ground contact pad. For example, in FIG. 11, the SDP shield 214 may be associated with a first SDP signal line having the unshielded drain portion 216 coupled to an extended ground contact pad, such as the ground contact pad 206. A second SDP shield 1102 may further include unshielded portions of SDP signal lines, indicated at 1104 and 1106, to be coupled to signal contact pads 1108 and 1110. An unshielded portion of a drain line, indicated at 1112, may also couple to the ground contact pad 206 extension. The arrangement of FIG. 11 provides decreased length inequalities as well as a reduction in ground contact pads that may be otherwise required.

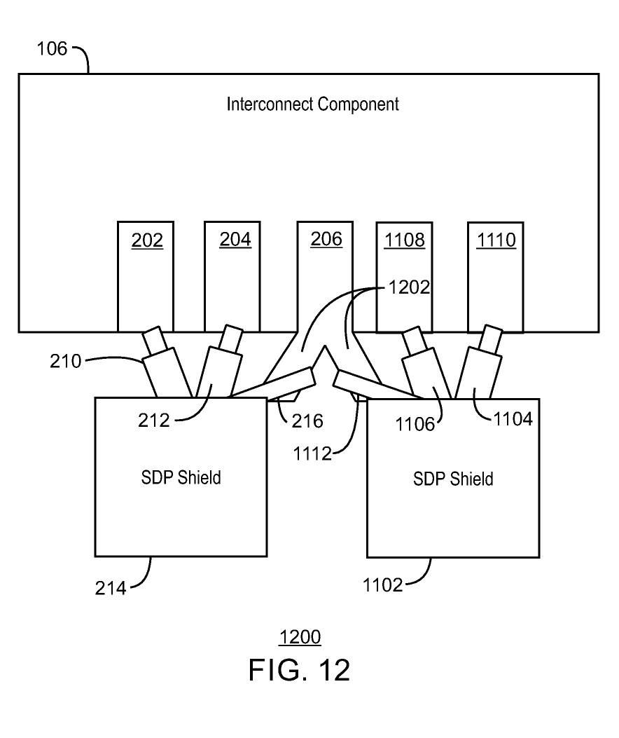

FIG. 12 is a block diagram illustrating an eleventh pad arrangement to reduce inequality in unshielded line lengths. Similar to the arrangement discussed above in regard to FIG. 11, the arrangement of the contact pads in FIG. 12 may provide decreased length inequalities as well as a reduction in ground contact pads that may be otherwise required. However, in FIG. 12, the ground contact pad 206 may be angled in two directions, as indicated at 1202. The angling may be towards a respective adjacent signal contact pad associated with a SDP signal line pair.

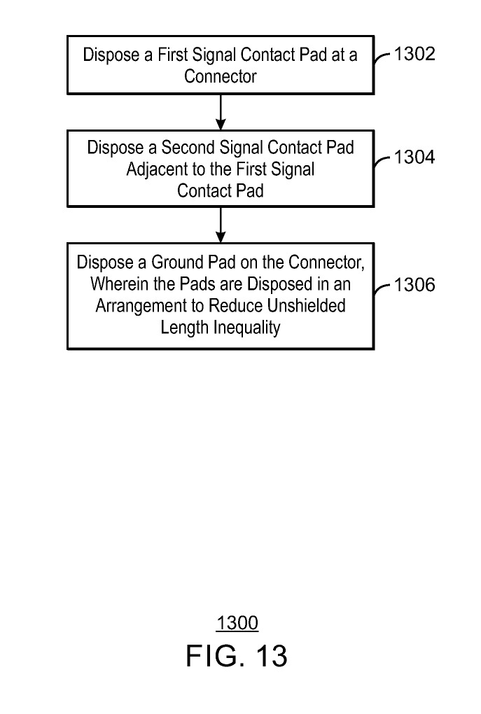

FIG. 13 is a block diagram illustrating a method for reducing inequality in unshielded line lengths. The method may include disposing, at block 1302, a first signal contact pad at a connector. As discussed above, the connector may be a interconnect component such as a paddle card.

At block 1304, a second signal contact pad is disposed adjacent to the first signal contact pad. At block 1306, a ground pad is disposed on the connector. The disposition of each of the contact pads includes arranging the contact pads relative to each other to reduce inequality between unshielded lengths of a first signal line, a second signal line, and a drain line to be respectively connected to the contact pads. The drain line may be a grounding line associated with a differential signal line pair including the first and second signal lines.

The arranging may comprise disposing the ground contact pad adjacent to the second signal contact pad. In some cases, spacing between the first signal contact pad and the second signal contact pad may be shorter than a distance between the ground contact pad and the second signal contact pad to reduce inequality in length of unshielded portions of lines to be connected.

In some cases, arranging includes disposing the ground contact pad beyond a linear boundary associated with the first signal contact pad and the second signal contact pad. As discussed above, the linear boundary may, in some cases, be associated with an edge of the interconnect component. Further, in some cases, the length of the ground contact pad may be longer than a length of either the first signal contact pad or the second signal contact pad.

In some cases, the arranging includes disposing at least a portion of the ground contact pad at an angle inward toward the second signal contact pad. In some cases the arranging includes disposing at least a portion of either the first or second contact pads at an angle either alone, or in combination with the angled ground contact pad.

In some cases, the interconnect component includes a top and bottom side. In this scenario, the arranging may include disposing the first and second signal contact pads on the topside of the interconnect card, and disposing the ground contact pad on the bottom side of the interconnect card to reduce the inequality between unshielded lengths of lines to be connected to the contacts pads.

In some cases, the interconnect component is an interconnect component having a recess. In these scenarios, the arranging may include disposing the signal contact pads in a recess of the interconnect card, and disposing the ground contact pad outside of the recess while adjacent to one of the signal contact pads.

Examples may include subject matter such as a method, means for performing acts of the method, at least one machine-readable medium including instructions that, when performed by a machine cause the machine to performs acts of the method, or of an apparatus or system for projecting a virtual image according to embodiments and examples described herein.

Example 1 includes an apparatus for signal line connecting. The apparatus includes a first signal contact pad, and a second signal contact pad adjacent to the first signal contact pad. The apparatus further includes a ground pad. The contact pads are disposed in an arrangement reducing inequality between unshielded lengths of a first signal line, a second signal line, and a drain line lines to be respectively connected to the first signal contact pad, the second signal contact pad, and the ground contact pad.

In Example 1, the drain line may be a grounding line associated with a shielded differential signal line pair comprising the first and second signal lines, and the ground contact pad is adjacent to the second signal contact pad. Spacing between the first signal contact pad and the second signal contact pad may be greater than spacing between the ground contact pad and the second signal contact pad.

In Example 1, the arrangement includes the ground contact pad disposed beyond a linear boundary associated with the first signal contact pad and the second signal contact pad. A length of the ground contact pad may be longer than a length of either the first signal contact pad or the second signal contact pad.

In some cases in Example 1, the arrangement includes at least a portion of the ground contact pad disposed at an angle inward toward the second signal contact pad. In some cases in Example 1, the contact pads are disposed on a interconnect component having a top side and a bottom side. The arrangement may include the first and second signal contact pads disposed on the topside of the interconnect component, the ground contact pad disposed on the bottom side of the interconnect component to reduce the inequality between unshielded lengths of lines to be connected to the contacts pads.

In some cases in Example 1, the arrangement may include the signal contact pads disposed in a recess of the interconnect component. In this case, the arrangement includes the ground contact pad disposed outside of the recess while adjacent to one of the signal contact pads.

The arrangement of Example 1 may include any combination of the cases presented above. For example, the arrangement may include extended ground pads that are angled.

Example 2 includes a method for signal line connecting. The method includes disposing a first signal contact pad at a connector, and disposing a second signal contact pad adjacent to the first signal contact pad. The method may also include disposing a ground pad on the connector. Disposing each of the contact pads includes arranging the contact pads relative to each other to reduce inequality between unshielded lengths of a first signal line, a second signal line, and a drain line to be respectively connected to the contacts pads.

In Example 2, the drain line may be a grounding line associated with a shielded differential signal line pair comprising the first and second signal lines, and the ground contact pad is adjacent to the second signal contact pad. Spacing between the first signal contact pad and the second signal contact pad may be greater than spacing between the ground contact pad and the second signal contact pad.

In Example 2, the arrangement includes the ground contact pad disposed beyond a linear boundary associated with the first signal contact pad and the second signal contact pad. A length of the ground contact pad may be longer than a length of either the first signal contact pad or the second signal contact pad.

In some cases in Example 2, the arrangement includes at least a portion of the ground contact pad disposed at an angle inward toward the second signal contact pad. In some cases in Example 2, the contact pads are disposed on a interconnect component having a top side and a bottom side. The arrangement may include the first and second signal contact pads disposed on the topside of the interconnect component, the ground contact pad disposed on the bottom side of the interconnect component to reduce the inequality between unshielded lengths of lines to be connected to the contacts pads.

In some cases in Example 2, the arrangement may include the signal contact pads disposed in a recess of the interconnect component. In this case, the arrangement includes the ground contact pad disposed outside of the recess while adjacent to one of the signal contact pads.

The arrangement of Example 2 may include any combination of the cases presented above. For example, the arrangement may include extended ground pads that are angled.

Example 3 includes a system for signal line connecting. The system includes an interconnect component and a first signal contact pad disposed on the interconnect component. The first signal contact pad is configured to be connected to a first signal line in a shielded differential signal line pair. The system also includes a second signal contact pad disposed on the interconnect component adjacent to the first signal contact pad. The second signal contact pad is configured to be connected to a second signal line in the shielded differential signal line pair. The system further includes a ground pad disposed on the interconnect component. The ground contact pad is configured to be connected to a drain line of the shielded differential signal line pair. The contact pads comprise an arrangement reducing inequality between unshielded lengths of the first signal line, the second signal line, and the drain line lines to be respectively connected to the first signal contact pad, the second signal contact pad, and the ground contact pad.

In Example 3, the drain line may be a grounding line associated with the shielded differential signal line pair comprising the first and second signal lines, and the ground contact pad is adjacent to the second signal contact pad. Spacing between the first signal contact pad and the second signal contact pad may be greater than spacing between the ground contact pad and the second signal contact pad.

In Example 3, the arrangement includes the ground contact pad disposed beyond a linear boundary associated with the first signal contact pad and the second signal contact pad. A length of the ground contact pad may be longer than a length of either the first signal contact pad or the second signal contact pad.

In some cases in Example 3, the arrangement includes at least a portion of the ground contact pad disposed at an angle inward toward the second signal contact pad. In some cases in Example 3, the contact pads are disposed on the interconnect component having a top side and a bottom side. The arrangement may include the first and second signal contact pads disposed on the topside of the interconnect component, the ground contact pad disposed on the bottom side of the interconnect component to reduce the inequality between unshielded lengths of lines to be connected to the contacts pads.

In some cases in Example 3, the arrangement may include the signal contact pads disposed in a recess of the interconnect component. In this case, the arrangement includes the ground contact pad disposed outside of the recess while adjacent to one of the signal contact pads.

The arrangement of Example 3 may include any combination of the cases presented above. For example, the arrangement may include extended ground pads that are angled.

Example 4 includes an apparatus for signal line connecting. The apparatus includes a first signal contact pad, and a second signal contact pad adjacent to the first signal contact pad. The apparatus further includes a ground pad. The contact pads are disposed in a means for reducing inequality between unshielded lengths of a first signal line, a second signal line, and a drain line lines to be respectively connected to the first signal contact pad, the second signal contact pad, and the ground contact pad.

In Example 4, the drain line may be a grounding line associated with a shielded differential signal line pair comprising the first and second signal lines, and the ground contact pad is adjacent to the second signal contact pad. Spacing between the first signal contact pad and the second signal contact pad may be greater than spacing between the ground contact pad and the second signal contact pad.

In Example 4, the means for reducing inequality includes the ground contact pad disposed beyond a linear boundary associated with the first signal contact pad and the second signal contact pad. A length of the ground contact pad may be longer than a length of either the first signal contact pad or the second signal contact pad.

In some cases in Example 4, the means for reducing inequality includes at least a portion of the ground contact pad disposed at an angle inward toward the second signal contact pad. In some cases in Example 4, the contact pads are disposed on a interconnect component having a top side and a bottom side. The means for reducing inequality may include the first and second signal contact pads disposed on the topside of the interconnect component, the ground contact pad disposed on the bottom side of the interconnect component to reduce the inequality between unshielded lengths of lines to be connected to the contacts pads.

In some cases in Example 4, the means for reducing inequality may include the signal contact pads disposed in a recess of the interconnect component. In this case, the means for reducing inequality includes the ground contact pad disposed outside of the recess while adjacent to one of the signal contact pads.

The means for reducing inequality of Example 4 may include any combination of the cases presented above. For example, the means for reducing inequality may include extended ground pads that are angled.

Example 5 includes a system for signal line connecting. The system includes an interconnect component and a first signal contact pad disposed on the interconnect component. The first signal contact pad is configured to be connected to a first signal line in a shielded differential signal line pair. The system also includes a second signal contact pad disposed on the interconnect component adjacent to the first signal contact pad. The second signal contact pad is configured to be connected to a second signal line in the shielded differential signal line pair. The system further includes a ground pad disposed on the interconnect component. The ground contact pad is configured to be connected to a drain line of the shielded differential signal line pair. The contact pads comprise a means for reducing inequality between unshielded lengths of the first signal line, the second signal line, and the drain line lines to be respectively connected to the first signal contact pad, the second signal contact pad, and the ground contact pad.

In Example 5, the drain line may be a grounding line associated with the shielded differential signal line pair comprising the first and second signal lines, and the ground contact pad is adjacent to the second signal contact pad. Spacing between the first signal contact pad and the second signal contact pad may be greater than spacing between the ground contact pad and the second signal contact pad.

In Example 5, the means for reducing inequality includes the ground contact pad disposed beyond a linear boundary associated with the first signal contact pad and the second signal contact pad. A length of the ground contact pad may be longer than a length of either the first signal contact pad or the second signal contact pad.

In some cases in Example 5, the means for reducing inequality includes at least a portion of the ground contact pad disposed at an angle inward toward the second signal contact pad. In some cases in Example 5, the contact pads are disposed on the interconnect component having a top side and a bottom side. The means for reducing inequality may include the first and second signal contact pads disposed on the topside of the interconnect component, the ground contact pad disposed on the bottom side of the interconnect component to reduce the inequality between unshielded lengths of lines to be connected to the contacts pads.

In some cases in Example 5, the arrangement may include the signal contact pads disposed in a recess of the interconnect component. In this case, the means for reducing inequality includes the ground contact pad disposed outside of the recess while adjacent to one of the signal contact pads.

The means for reducing inequality of Example 5 may include any combination of the cases presented above. For example, the means for reducing inequality may include extended ground pads that are angled.

Not all components, features, structures, characteristics, etc. described and illustrated herein need be included in a particular embodiment or embodiments. If the specification states a component, feature, structure, or characteristic “may”, “might”, “can” or “could” be included, for example, that particular component, feature, structure, or characteristic is not required to be included. If the specification or claim refers to “a” or “an” element, that does not mean there is only one of the element. If the specification or claims refer to “an additional” element, that does not preclude there being more than one of the additional element.

It is to be noted that, although some embodiments have been described in reference to particular implementations, other implementations are possible according to some embodiments. Additionally, the arrangement and/or order of circuit elements or other features illustrated in the drawings and/or described herein need not be arranged in the particular way illustrated and described. Many other arrangements are possible according to some embodiments.

In each system shown in a figure, the elements in some cases may each have a same reference number or a different reference number to suggest that the elements represented could be different and/or similar. However, an element may be flexible enough to have different implementations and work with some or all of the systems shown or described herein. The various elements shown in the figures may be the same or different. Which one is referred to as a first element and which is called a second element is arbitrary.

It is to be understood that specifics in the aforementioned examples may be used anywhere in one or more embodiments. For instance, all optional features of the computing device described above may also be implemented with respect to either of the methods or the computer-readable medium described herein. Furthermore, although flow diagrams and/or state diagrams may have been used herein to describe embodiments, the techniques are not limited to those diagrams or to corresponding descriptions herein. For example, flow need not move through each illustrated box or state or in exactly the same order as illustrated and described herein.

The present techniques are not restricted to the particular details listed herein. Indeed, those skilled in the art having the benefit of this disclosure will appreciate that many other variations from the foregoing description and drawings may be made within the scope of the present techniques. Accordingly, it is the following claims including any amendments thereto that define the scope of the present techniques.

What is claimed is:

1. An apparatus for signal line connecting, comprising:
a first signal contact pad;
a second signal contact pad adjacent to the first signal contact pad; and
a ground pad, wherein the contact pads are disposed in an arrangement reducing inequality between unshielded lengths of a first signal line, a second signal line, and a drain line lines to be respectively connected to the first signal contact pad, the second signal contact pad, and the ground contact pad.

2. The apparatus of claim 1, wherein the drain line is a grounding line associated with a shielded differential signal line pair comprising the first and second signal lines.

3. The apparatus of claim 1, wherein the ground contact pad is adjacent to the second signal contact pad.

4. The apparatus of claim 3, wherein spacing between the first signal contact pad and the second signal contact pad is greater than spacing between the ground contact pad and the second signal contact pad.

5. The apparatus of claim 3, wherein the arrangement comprises the ground contact pad disposed beyond a linear boundary associated with the first signal contact pad and the second signal contact pad.

6. The apparatus of claim 5, wherein a length of the ground contact pad is longer than a length of either the first signal contact pad or the second signal contact pad.

7. The apparatus of claim 3, wherein the arrangement comprises at least a portion of the ground contact pad disposed at an angle inward toward the second signal contact pad.

8. The apparatus of claim 1, wherein the contact pads are disposed on a interconnect component.

9. The apparatus of claim 7, wherein the interconnect component comprises a top side and a bottom side, and wherein the arrangement comprises:
the first and second signal contact pads disposed on the topside of the interconnect component; and
the ground contact pad disposed on the bottom side of the interconnect component to reduce the inequality between unshielded lengths of lines to be connected to the contacts pads.

10. The apparatus of claim 7, wherein the interconnect component comprises a recess, and wherein the arrangement comprises:
the signal contact pads disposed in the recess of the interconnect component; and
the ground contact pad disposed outside of the recess while adjacent to one of the signal contact pads.

11. A method for signal line connecting, comprising:
disposing a first signal contact pad at a connector;
disposing a second signal contact pad adjacent to the first signal contact pad; and
disposing a ground pad on the connector, wherein the disposing each of the contact pads comprises arranging the contact pads relative to each other to reduce inequality between unshielded lengths of a first signal line, a second signal line, and a drain line to be respectively connected to the contacts pads.

12. The method of claim 11, wherein the drain line is a grounding line associated with a shielded differential signal line pair comprising the first and second signal lines.

13. The method of claim 11, wherein arranging comprises disposing the ground contact pad adjacent to the second signal contact pad.

14. The method of claim 13, wherein arranging further comprises:
spacing the first signal contact pad and the second signal contact pad at a first distance;
spacing the ground contact pad and the second signal contact pad at a second distance greater than the first distance.

15. The method of claim 13, wherein arranging comprises disposing the ground contact pad beyond a linear boundary associated with the first signal contact pad and the second signal contact pad.

16. The method of claim 15, wherein a length of the ground contact pad is longer than a length of either the first signal contact pad or the second signal contact pad.

17. The method of claim 13, wherein arranging comprises disposing at least a portion of the ground contact pad at an angle inward toward the second signal contact pad.

18. The method of claim 11, wherein the connector comprises an interconnect card, and wherein the contact pads are disposed on the interconnect card.

19. The method of claim 17, wherein the interconnect card comprises a top side and a bottom side, and wherein arranging comprises:
disposing the first and second signal contact pads on the topside of the interconnect card; and
disposing the ground contact pad on the bottom side of the interconnect card to reduce the inequality between unshielded lengths of lines to be connected to the contacts pads.

20. The method of claim 17, wherein the interconnect card comprises a recess, and wherein arranging comprises:
disposing the signal contact pads in the recess of the interconnect card; and
disposing the ground contact pad outside of the recess while adjacent to one of the signal contact pads.

21. A system for signal line connecting, comprising:
an interconnect component;
a first signal contact pad disposed on the interconnect component, the first signal contact pad to be connected to a first signal line in a shielded differential signal line pair;
a second signal contact pad disposed on the interconnect component adjacent to the first signal contact pad, the second signal contact pad to be connected to a second signal line in the shielded differential signal line pair; and
a ground pad disposed on the interconnect component, the ground contact pad to be connected to a drain line of the shielded differential signal line pair, wherein the contact pads comprise an arrangement reducing inequality between unshielded lengths of the first signal line, the second signal line, and the drain line lines to be respectively connected to the first signal contact pad, the second signal contact pad, and the ground contact pad.

22. The system of claim 21, wherein the ground contact pad is adjacent to the second signal contact pad.

23. The system of claim 22, wherein the arrangement comprises the ground contact pad disposed beyond a linear boundary associated with the first signal contact pad and the second signal contact pad.

24. The system of claim 23, wherein the arrangement comprises at least a portion of the ground contact pad disposed at an angle inward toward the second signal contact pad.

25. The system of claim 21, wherein the contact pads are disposed on a interconnect component comprising a top side and a bottom side, and wherein the arrangement comprises:
the first and second signal contact pads disposed on the topside of the interconnect component; and
the ground contact pad disposed on the bottom side of the interconnect component to reduce the inequality between unshielded lengths of lines to be connected to the contacts pads.
